(19) United States
(12) Patent Application Publication
(10) Pub. No.: US 2019/0228343 A1
(43) Pub. Date: Jul. 25, 2019

(54) FLEXIBLE CONFIGURATION OF MODEL TRAINING PIPELINES

(71) Applicant: Microsoft Technology Licensing, LLC, Redmond, WA (US)

(72) Inventors: Songxiang Gu, Sunnyvale, CA (US); Xuebin Yan, Sunnyvale, CA (US); Shihai He, Fremont, CA (US); Andris Birkmanis, Redwood City, CA (US); Fei Chen, Saratoga, CA (US); Yu Gong, Santa Clara, CA (US); Chang-Ming Tsai, Fremont, CA (US); Siyao Sun, Jersey City, NJ (US); Joel D. Young, Milpitas, CA (US)

(73) Assignee: Microsoft Technology Licensing, LLC, Redmond, WA (US)

(21) Appl. No.: 15/878,186

(22) Filed: Jan. 23, 2018

(51) Int. Cl. G06N 99/00

(52) U.S. Cl. CPC G06N 99/005

(57) ABSTRACT

The disclosed embodiments provide a system for processing data. During operation, the system obtains a model definition and a training configuration for a machine-learning model, wherein the training configuration includes a set of required features, a training technique, and a scoring function. Next, the system uses the model definition and the training configuration to load the machine-learning model and the set of required features into a training pipeline without requiring a user to manually identify the set of required features. The system then uses the training pipeline and the training configuration to update a set of parameters for the machine-learning model. Finally, the system stores mappings containing the updated set of parameters and the set of required features in a representation of the machine-learning model.

### BACKGROUND

### Field

The disclosed embodiments relate to data analysis and machine learning. More specifically, the disclosed embodiments relate to techniques for performing flexible configuration of model training pipelines.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of machine-learning models. The discovered information may then be used to guide decisions and/or perform actions related to the data. For example, the output of a machine-learning model may be used to guide marketing decisions, assess risk, detect fraud, predict behavior, and/or customize or optimize use of an application or website.

However, significant time, effort, and overhead may be spent on feature selection during creation and training of machine-learning models for analytics. For example, a data set for a machine-learning model may have thousands to millions of features, including features that are created from combinations of other features, while only a fraction of the features and/or combinations may be relevant and/or important to the machine-learning model. At the same time, training and/or execution of machine-learning models with large numbers of features typically require more memory, computational resources, and time than those of machine-learning models with smaller numbers of features. Excessively complex machine-learning models that utilize too many features may additionally be at risk for overfitting.

Additional overhead and complexity may be incurred during sharing and organizing of feature sets. For example, a set of features may be shared across projects, teams, or usage contexts by denormalizing and duplicating the features in separate feature repositories for offline and online execution environments. As a result, the duplicated features may occupy significant storage resources and require synchronization across the repositories. Each team that uses the features may further incur the overhead of manually identifying features that are relevant to the team's operation from a much larger list of features for all of the teams. The same features may further be identified and/or specified multiple times during different steps associated with creating, training, validating, and/or executing the same machine-learning model.

Consequently, creation and use of machine-learning models in analytics may be facilitated by mechanisms for improving the monitoring, management, sharing, propagation, and reuse of features among the machine-learning models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a flowchart illustrating a process of executing a training pipeline for a machine-learning model in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

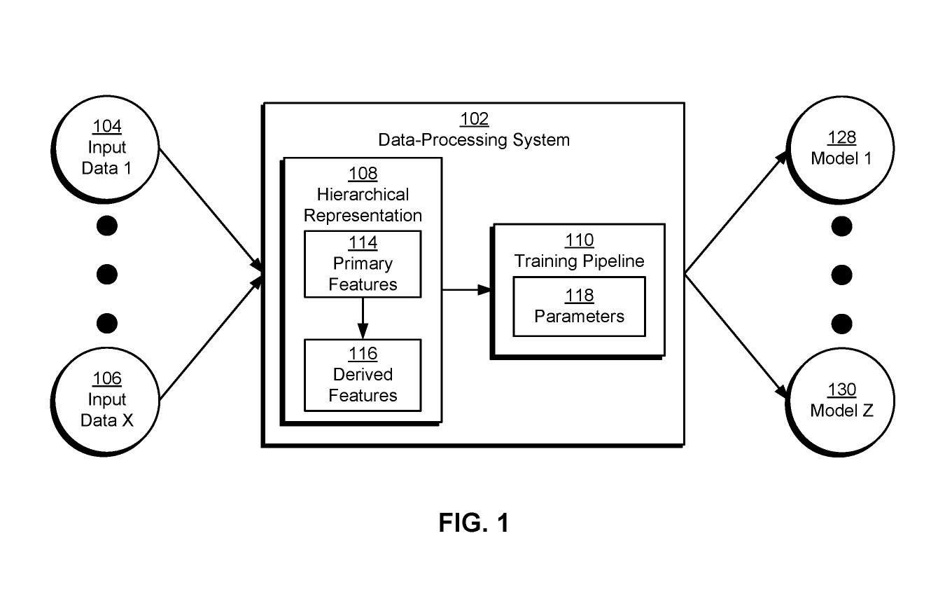

The disclosed embodiments provide a method, apparatus, and system for processing data. As shown in FIG. 1, the system includes a data-processing system 102 that analyzes one or more sets of input data (e.g., input data 1 104, input data x 106). For example, data-processing system 102 may create and train one or more machine-learning models (e.g., model 1 128, model z 130) for analyzing input data related to users, organizations, applications, job postings, purchases, electronic devices, websites, content, sensor measurements, and/or other categories. The models may include, but are not limited to, regression models, artificial neural networks, support vector machines, decision trees, naïve Bayes classifiers, Bayesian networks, deep learning models, hierarchical models, and/or ensemble models.

In turn, the results of such analysis may be used to discover relationships, patterns, and/or trends in the data; gain insights from the input data; and/or guide decisions or actions related to the data. For example, data-processing system 102 may use the machine-learning models to generate output that includes scores, classifications, recommendations, estimates, predictions, and/or other properties or inferences.

The output may be inferred or extracted from primary features 114 in the input data and/or derived features 116 that are generated from primary features 114 and/or other derived features 116. For example, primary features 114 may include profile data, user activity, sensor data, and/or other data that is extracted directly from fields or records in the input data. The primary features 114 may be aggregated, scaled, combined, and/or otherwise transformed to produce derived features 116, which in turn may be further combined or transformed with one another and/or the primary features to generate additional derived features. After the output is generated from one or more sets of primary and/or derived features, the output is provided in responses to queries of data-processing system 102. In turn, the queried output may improve revenue, interaction with the users and/or organizations, use of the applications and/or content, and/or other metrics associated with the input data.

In one or more embodiments, primary features 114 and/or derived features 116 are obtained and/or used with a community of users, such as an online professional network that is used by a set of entities to interact with one another in a professional, social, and/or business context. The entities may include users that use the online professional network to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

As a result, primary features 114 and/or derived features 116 may include member features, company features, and/or job features. The member features include attributes from the members' profiles with the online professional network, such as each member's title, skills, work experience, education, seniority, industry, location, and/or profile completeness. The member features also include each member's number of connections in the social network, the member's tenure on the social network, and/or other metrics related to the member's overall interaction or “footprint” in the online professional network. The member features further include attributes that are specific to one or more features of the online professional network, such as a classification of the member as a job seeker or non-job-seeker.

The member features may also characterize the activity of the members with the online professional network. For example, the member features may include an activity level of each member, which may be binary (e.g., dormant or active) or calculated by aggregating different types of activities into an overall activity count and/or a bucketized activity score. The member features may also include attributes (e.g., activity frequency, dormancy, total number of user actions, average number of user actions, etc.) related to specific types of social or online professional network activity, such as messaging activity (e.g., sending messages within the social network), publishing activity (e.g., publishing posts or articles in the social network), mobile activity (e.g., accessing the social network through a mobile device), job search activity (e.g., job searches, page views for job listings, job applications, etc.), and/or email activity (e.g., accessing the social network through email or email notifications).

The company features include attributes and/or metrics associated with companies. For example, company features for a company may include demographic attributes such as a location, an industry, an age, and/or a size (e.g., small business, medium/enterprise, global/large, number of employees, etc.) of the company. The company features may further include a measure of dispersion in the company, such as a number of unique regions (e.g., metropolitan areas, counties, cities, states, countries, etc.) to which the employees and/or members of the online professional network from the company belong.

A portion of company features may relate to behavior or spending with a number of products, such as recruiting, sales, marketing, advertising, and/or educational technology solutions offered by or through the online professional network. For example, the company features may also include recruitment-based features, such as the number of recruiters, a potential spending of the company with a recruiting solution, a number of hires over a recent period (e.g., the last 12 months), and/or the same number of hires divided by the total number of employees and/or members of the online professional network in the company. In turn, the recruitment-based features may be used to characterize and/or predict the company's behavior or preferences with respect to one or more variants of a recruiting solution offered through and/or within the online professional network.

The company features may also represent a company's level of engagement with and/or presence on the online professional network. For example, the company features may include a number of employees who are members of the online professional network, a number of employees at a certain level of seniority (e.g., entry level, mid-level, manager level, senior level, etc.) who are members of the online professional network, and/or a number of employees with certain roles (e.g., engineer, manager, sales, marketing, recruiting, executive, etc.) who are members of the online professional network. The company features may also include the number of online professional network members at the company with connections to employees of the online professional network, the number of connections among employees in the company, and/or the number of followers of the company in the online professional network. The company features may further track visits to the online professional network from employees of the company, such as the number of employees at the company who have visited the online professional network over a recent period (e.g., the last 30 days) and/or the same number of visitors divided by the total number of online professional network members at the company.

One or more company features may additionally be derived features 116 that are generated from member features. For example, the company features may include measures of aggregated member activity for specific activity types (e.g., profile views, page views, jobs, searches, purchases, endorsements, messaging, content views, invitations, connections, recommendations, advertisements, etc.), member segments (e.g., groups of members that share one or more common attributes, such as members in the same location and/or industry), and companies. In turn, the company features may be used to glean company-level insights or trends from member-level online professional network data, perform statistical inference at the company and/or member segment level, and/or guide decisions related to business-to-business (B2B) marketing or sales activities.

The job features describe and/or relate to job listings and/or job recommendations within the online professional network. For example, the job features may include declared or inferred attributes of a job, such as the job's title, industry, seniority, desired skill and experience, salary range, and/or location. One or more job features may also be derived features 116 that are generated from member features and/or company features. For example, the job features may provide a context of each member's impression of a job listing or job description. The context may include a time and location (e.g., geographic location, application, website, web page, etc.) at which the job listing or description is viewed by the member. In another example, some job features may be calculated as cross products, cosine similarities, statistics, and/or other combinations, aggregations, scaling, and/or transformations of member features, company features, and/or other job features.

In one or more embodiments, data-processing system 102 uses a hierarchical representation 108 of features 114 and derived features 116 to organize the sharing, production, and use of the features across different teams, execution environments, and/or projects. Hierarchical representation 108 may include a directed acyclic graph (DAG) that defines a set of namespaces for primary features 114 and derived features 116. The namespaces may disambiguate among features with similar names or definitions from different usage contexts or execution environments. Hierarchical representation 108 may include additional information that can be used to locate primary features 114 in different execution environments, calculate derived features 116 from the primary features and/or other derived features, and track the development of machine-learning models or applications that accept the derived features as input.

For example, primary features 114 and derived features 116 in hierarchical representation 108 may be uniquely identified by strings of the form “[entityName].[fieldname].” The “fieldname” portion may include the name of a feature, and the “entityName” portion may form a namespace for the feature. Thus, a feature name of “skills” may be appended to namespaces such as “member,” “company,” and/or “job” to disambiguate between features that share the feature name but are from different teams, projects, sources, feature sets, contexts, and/or execution environments.

In one or more embodiments, data-processing system 102 uses a training pipeline 110 and flexible training configurations for the machine-learning models to train parameters 118 of the models. For example, data-processing system 102 may include functionality to obtain model definitions of the models separately from training configurations that specify required features, training techniques, scoring functions, and/or other options for training the models using training pipeline. Such separation decouples users and processes for creating and defining models from those involved in training parameters 118 of the models, thereby allowing different models to be used with the same training pipeline and/or the same model to be used with multiple training pipelines.

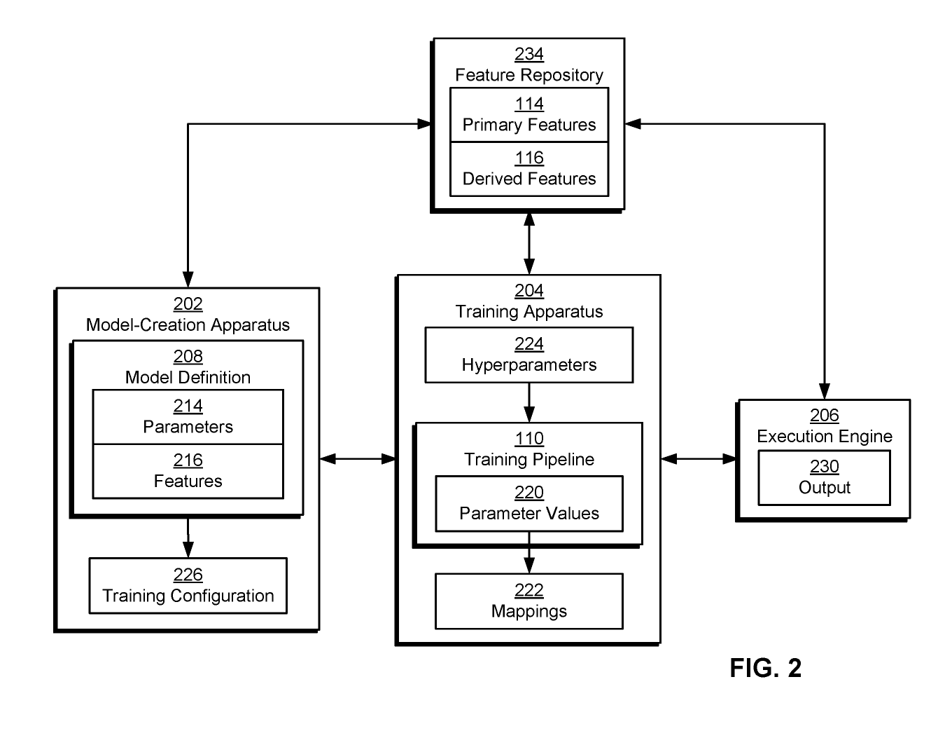

FIG. 2 shows a system for processing data (e.g., data-processing system 102 of FIG. 1) in accordance with the disclosed embodiments. As shown in FIG. 2, the system includes a model-creation apparatus 202, a training apparatus 204, and an execution engine 206. Each of these components is described in further detail below.

Model-creation apparatus 202 obtains a model definition 208 and a training configuration 226 for a machine-learning model. For example, model-creation apparatus 202 may obtain model definition 208 and/or training configuration 226 from one or more configuration files, user-interface elements, and/or other mechanisms for obtaining user input and/or interacting with a user.

Model definition 208 defines parameters 214 and features 216 in the machine-learning model. Features 216 may include primary features 114 and/or derived features 116 that are obtained from a feature repository 234 and/or calculated from other features, as described above. For example, model definition 208 may include names, types, and/or sources of features 216 inputted into the machine-learning model.

Parameters 214 may specify the names and types of regression coefficients, neural network weights, and/or other attributes that control the behavior of the machine-learning model. As a result, parameters 214 may be set and/or tuned based on values of features 216 inputted into the machine-learning model.

An exemplary model definition 208 for a machine-learning model may include the following:

IMPORT com.linkedin.quasar.interpreter.SampleFeatureProducers;
MODELID “quasar_test_model”;
MODEL PARAM Map<String, Object> scoreWeights = { };
MODEL PARAM Map<String, Object> constantWeights = {

“extFeature5” : {“term1”: 1.0, “term2”: 2.0, “term3”: 3.0}

};
MODEL PARAM String limember = “member”;
DOCPARAM String lijob;
EXTERNAL REQUEST FEATURE Float extFeature1 WITH
NAME “e1” WITH KEY “key”;
EXTERNAL REQUEST FEATURE Float extFeature2 WITH
NAME “e2” WITH KEY “key”;
EXTERNAL DOCUMENT FEATURE VECTOR<SPARSE>
extFeature3 WITH NAME “e3” WITH KEY “key”;
EXTERNAL DOCUMENT FEATURE VECTOR<SPARSE>
extFeature4 WITH NAME “e4” WITH KEY “key”;
EXTERNAL DOCUMENT FEATURE VECTOR<SPARSE>
extFeature5 WITH NAME “e5” WITH KEY “key”;
REQUEST FEATURE float value3 =
SampleFeatureProducers$DotProduct(extFeature1, extFeature2);
DOCUMENT FEATURE float value4 =
SampleFeatureProducers$DotProduct(extFeature2, extFeature3);
DOCUMENT FEATURE float score =
SampleFeatureProducers$MultiplyScore(value3, value4, extFeature3);
result = ORDER DOCUMENTS BY score WITH DESC;
RETURN result;

The exemplary model definition 208 above includes a model name of “quasar_test_model.” The exemplary model definition 208 also specifies two sets of parameters 214: a first set of “scoreWeights” with values to be set during training of the model and a second set of “constantWeights” with names of “term1,” “term2,” and “term3” and corresponding fixed values of 1.0, 2.0, and 3.0.

The exemplary model definition 208 also includes a series of requests for five external features named “extFeature1,” “extFeature2,” “extFeature3,” “extFeature4,” and “extFeature5.” The first two features have a type of “Float,” and the last three features have a type of “VECTOR<SPARSE>.” The external features may be primary features 114 and/or derived features 116 that are retrieved from a feature repository (e.g., feature repository 234) named “SampleFeatureProducers” using the corresponding names of “e1,” “e2,” “e3,” “e4,” and “e5” and the same key of “key.”

The exemplary model definition 208 further specifies a set of derived features 116 that are calculated from the five external features. The set of derived features 116 includes a feature with a name of “value3” and a type of “float” that is calculated as the dot product of “extFeature1” and “extFeature2.” The set of derived features 116 also includes a feature with a name of “value4” and a type of “float” that is calculated as the dot product of “extFeature2” and “extFeature3.” The set of derived features 116 further includes a feature with a name of “score” and a type of “float” that is calculated using a function named “MultiplyScore” and arguments of “value3,” “value4,” and “extFeature3.” Finally, the exemplary model definition 208 defines and returns a “result” that is ordered by descending “score.”

The exemplary model definition 208 may be accompanied by the following exemplary training configuration 226:
TRAINING CONFIG trainingConfig1 SCORING BY score REQUIRED WEIGHT PAIRS ([value3, value4, extFeature3], scoreWeights), ([extFeature5], constantWeights) OFFSET WEIGHTS constantWeights ALGORITHM “logistic”;
   The exemplary training configuration 226 may be included in the same file or location as model definition 208, or the exemplary training configuration 226 may be found in a separate file or location.

The exemplary training configuration 226 above has a name of “trainingConfig1,” a scoring function (e.g., “SCORING BY”) represented by “score” in the corresponding model definition 208, and a set of “REQUIRED WEIGHT PAIRS” that contain mappings 222 of features 216 from model definition 208 to parameters 214 applied to features 216. The first mapping includes features 216 of “value3,” “value4,” and “ExtFeature3” and parameters 214 represented by “scoreWeights.” The second mapping includes a feature of “extFeature5” and parameters 214 represented by “constantWeights.”

The exemplary training configuration 226 above also identifies a set of “OFFSET WEIGHTS” represented by “constantWeights.” The offset weights may represent parameters 214 of the machine-learning model that are not subject to training. Instead, the offset weights may be set to default and/or fixed values, such as the values of “term1,” “term2,” and “term3” from the corresponding model definition 208.

After model definition 208 and training configuration 226 are created, training apparatus 204 uses model definition 208 and training configuration 226 to train parameter values 220 for parameters 214 in the machine-learning model. In particular, training apparatus 204 uses model definition 208 and training configuration 226 to load the machine-learning model into a training pipeline 110. For example, training apparatus 204 may provide an application-programming interface (API) and/or other mechanism for configuring the execution of training pipeline 110. In turn, a user may use the mechanism to load model definition 208 and training configuration 226 into training pipeline 110 and use training pipeline 110 to update parameter values 220 for parameters 214 of the machine-learning model.

Training apparatus 204 also obtains a number of hyperparameters used to train the machine-learning model. For example, the hyperparameters may include a regularization parameter for controlling the amount of personalization of the machine-learning model to individual users or entities and/or a convergence parameter that adjusts the rate of convergence of the machine-learning model. In another example, the hyperparameters may include a clustering parameter that controls the amount of clustering (e.g., number of clusters) in a clustering technique and/or classification technique that utilizes clusters. In a third example, the hyperparameters may specify a feature complexity for features inputted into the machine-learning model, such as the number of topics or items in n-grams used during natural language processing. In a fourth example, the hyperparameters may include a model training parameter that controls training of the machine-learning model, such as a step size or momentum in a gradient descent technique. In a fifth example, the hyperparameters may include a model selection parameter that specifies the type of the machine-learning model (e.g., logistic regression, artificial neural network, support vector machine, decision tree, deep-learning model, etc.). In a sixth example, the hyperparameters may include a decay parameter, such as a parameter for determining an annealing schedule in simulated annealing. In a seventh example, the hyperparameters may include “hyper-hyperparameters,” such as starting positions, default values, and/or other parameters related to exploring a search space for other hyperparameters. In an eighth example, the hyperparameters may include a threshold, such as a threshold for removing links with low weights in artificial neural networks.

Training apparatus 204 then uses training pipeline 110 to update parameter values 220 of parameters 214 according to training configuration 226, values of features 216 from feature repository 234, hyperparameters for training the machine-learning model, and/or other options specified by a user. The trained parameter values 220 are then stored in mappings 222 of parameters 214 to the corresponding features 216, as specified in training configuration 226.

The following exemplary API calls may be used with the exemplary model definition 208 and training configuration 226 above to create and execute training pipeline 110 for a machine-learning model:

val quasarModel =
QuasarModelLoader.loadQuasarModel(“quasar_model_file.quasar”)
val trainingConfig = quasarModel.getTrainingConfig(“trainingConfig1”);
val trainingVectors = trainingDataRecords.forEach(

val executor = quasarModel.getExecutor(param,
ScoringRequestConfig.getDefault, requestExternalFeature)
val scorable = executor.score(entity, documentExternalFeature).head
val offset = trainingConfig.getOffsetValue(scorable)
val features = trainingConfig.getTrainingFeatures(scorable)
(features, offset)

).collect( )
val estimator = new LogisticRegressionEstimator( )
.setTaskType(params.taskType)
.setUpdatingSequence(params.updatingSequence)
.setNumOuterIterations(params.numIterations)
.setFixedEffectDataConfigurations(params.fixedEffectDataConfigurations)
.setFeatureShardColumnNames(params.featureShardIdToFeatureSection
KeysMap.keySet)
val trainedCoefficients: Seq[(LogisticRegressionModel,
Option[EvaluationResults],
LogisticRegressionModelOptimizationConfiguration)] =
estimator.fittimator.fit(trainingVectors, None,
params.getAllModelConfigs)
trainingConfig.setWeights(trainedCoefficients)
quasarModel.writeToDisk( );

The exemplary API calls are used to load model definition 208 from a file named “quasar_model_file.quasar” and select training configuration 226 from the loaded model definition 208. After model definition 208 and training configuration 226 are retrieved from the file, a set of “trainingDataRecords” and a series of additional API calls is used to obtain and/or calculate the corresponding features 216, the scoring function, and/or fixed values associated with offset weights in the machine-learning model. The features and corresponding offset values are loaded into a set of “training Vectors.”

An estimator named “LogisticRegressionEstimator” is then initialized using a number of options (e.g., hyperparameters) for controlling training of the machine-learning model, including a “taskType,” an “updatingSequence,” a “numIterations,” a set of “fixedEffectDataConfigurations,” and a set of “featureShardIdToFeatureSectionKeysMap.” The options are then used with the estimator and features and offset weights from “training Vectors” to generate a set of “trainedCoefficients” representing parameter values 220 (e.g., “scoreWeights” from model definition 208) of the machine-learning model. Finally, the “trainedCoefficients” are set as parameter values 220 associated with training configuration 226, and the trained machine-learning model is written to disk with parameter values 220 in the corresponding mappings 222.

In turn, the exemplary model definition 208 may be updated to include the following:

IMPORT com.linkedin.quasar.interpreter.SampleFeatureProducers;
MODELID ″quasar_test_model″;
MODEL PARAM Map<String, Object> scoreWeights = {

“value3”: 1.0,
“value4”: 1.5,
“extFeature3” : {“term1”: 4.0, “term2”: 5.0, “term3”: 6.0}

};
MODEL PARAM Map<String, Object> constantWeights = {

″extFeature5″ : {″term1″: 1.0, ″term2″: 2.0, ″term3″: 3.0}

};
MODEL PARAM String limember = ″member″;
DOCPARAM String lijob;
EXTERNAL REQUEST FEATURE Float extFeature1 WITH
NAME ″e1″ WITH KEY ″key″;
EXTERNAL REQUEST FEATURE Float extFeature2 WITH
NAME ″e2″ WITH KEY ″key″;
EXTERNAL DOCUMENT FEATURE VECTOR<SPARSE>
extFeature3 WITH NAME ″e3″ WITH KEY ″key″;
EXTERNAL DOCUMENT FEATURE VECTOR<SPARSE>
extFeature4 WITH NAME ″e4″ WITH KEY ″key″;
EXTERNAL DOCUMENT FEATURE VECTOR<SPARSE>
extFeature5 WITH NAME ″e5″ WITH KEY ″key″;
REQUEST FEATURE float value3 =
SampleFeatureProducers$DotProduct(extFeature1, extFeature2);
DOCUMENT FEATURE float value4 =
SampleFeatureProducers$DotProduct(extFeature2, extFeature3);
DOCUMENT FEATURE float score =
SampleFeatureProducers$MultiplyScore(value3, value4, extFeature3);
result = ORDER DOCUMENTS BY score WITH DESC;
RETURN result;

In the updated model definition 208, a subset of parameters 214 represented by “scoreWeights” is populated with parameter names of “value3,” “value4,” and “extFeature3,” indicating that the parameters in “scoreWeights” are applied to features with the same names. The “value3” parameter has a value of 1.0 that is applied to the “value3” feature, the “value4” parameter has a value of 1.5 that is applied to the “value4” parameter, and the “extFeature3” parameter includes three components named “term1,” “term2,” and “term3” with the corresponding values of 1.0, 2.0, and 3.0 that are applied to three different components of the “extFeature3” feature vector. The values of parameters 214 in “scoreWeights” may be generated by training pipeline 110 according to the API calls above, parameters 214 and features 216 defined using model definition 208, and mappings 222 of parameters 214 to features 216 from training configuration 226.

Conversely, the same parameter names and parameter values 220 are maintained in “constantWeights” before and after training of the machine-learning model. The lack of change to “constantWeights” reflects the inclusion of “constantWeights” as “OFFSET WEIGHTS” that are not updated during training of the machine-learning model.

Finally, execution engine 206 uses parameter values 220 from the trained machine-learning model to generate output 230 that includes scores, classifications, recommendations, estimates, predictions, and/or other inferences or properties. For example, execution engine 206 may apply the machine-learning model to additional sets of features from feature repository 234, an event stream, and/or another data source to generate output 230 on a real-time, nearline, and/or offline basis. Parameter values 220 may be obtained from model definition 208 and/or another representation of the machine-learning model that is generated from model definition 208. In turn, output 230 may be used to supplement or perform real-world tasks such as managing the execution of an application, personalizing user experiences, managing relationships, making clinical decisions, carrying out transactions, operating autonomous vehicles or machines, and/or analyzing metrics or measurements.

By decoupling the definition of the machine-learning model and the associated parameters 214 and features 216 from options for training and/or updating the machine-learning model, the system of FIG. 2 may provide separation of concerns that reduces overhead, user error, and/or interdependency between the creation and training of the machine-learning model. The system may further enable a many-to-many relationship between machine-learning models and training pipelines for the machine-learning models, thus increasing the flexibility associated with configuring the creation and training of the machine-learning models. Consequently, the system may improve technologies for creating, training, and/or executing machine-learning models, as well as applications, distributed systems, and/or computer systems that execute the technologies and/or machine-learning models.

Those skilled in the art will appreciate that the system of FIG. 2 may be implemented in a variety of ways. First, model-creation apparatus 202, training apparatus 204, execution engine 206, and/or feature repository 234 may be provided by a single physical machine, multiple computer systems, one or more virtual machines, a grid, one or more databases, one or more filesystems, and/or a cloud computing system. Model-creation apparatus 202, training apparatus 204, and execution engine 206 may additionally be implemented together and/or separately by one or more hardware and/or software components and/or layers. Moreover, various components of the system may be configured to execute in an offline, online, and/or nearline basis to perform different types of processing related to creating, training, and/or executing machine-learning models.

Second, model definition 208, training configuration 226, parameter values 220, mappings 222, primary features 114, derived features 116, and/or other data used by the system may be stored, defined, and/or transmitted using a number of techniques. For example, the system may be configured to accept features from different types of repositories, including relational databases, graph databases, data warehouses, filesystems, and/or flat files. The system may also obtain and/or transmit model definition 208, training configuration 226, calls for creating training pipeline 110, parameter values 220, and/or mappings 222 in a number of formats, including database records, property lists, Extensible Markup language (XML) documents, JavaScript Object Notation (JSON) objects, source code, and/or other types of structured data.

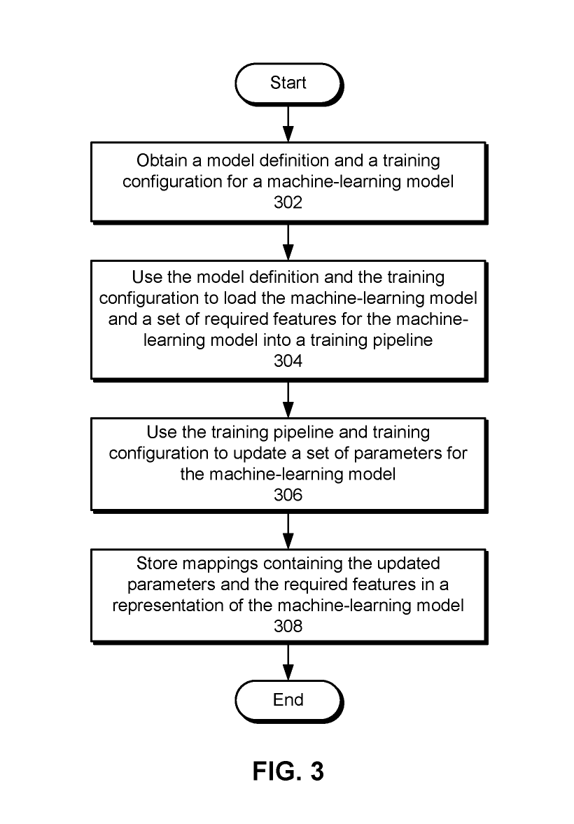

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

Initially, a model definition and a training configuration for a machine-learning model are obtained (operation 302). For example, the model definition and training configuration may be obtained from the same configuration file and/or separate configuration files. The model definition may include feature names and feature types of features inputted into the machine-learning model. The training configuration may include a set of required features, parameters to be applied to the required features, a training technique, and/or a scoring function used to train the machine-learning model.

An exemplary model definition and training configuration for a tree-based machine-learning model may include the following:

MODEL PARAM String tree_model = “”;
DOCPARAM LiJob lijob;
DOCUMENT FEATURE VECTOR<SPARSE> treeFeature =
com.linkedin.quasar.featureproducer.DecisionTreesProducer(

tree_model, “weightedsum”, true, [1.0, 1.0],
{“indexMap”: “dynamicIndexMap”, “type”: “SPARSE”});

TRAINING CONFIG config1 SCORING BY treeFeature REQUIRED
WEIGHT
PAIRS ([feature_1, feature_2], tree_model) ALGORITHM “xgboost”;
RETURN DOCUMENTS;

The exemplary model definition above may include a set of parameters named “tree_model” and a set of features with a name of “treeFeature” and a type of “VECTOR<SPARSE>.” The features may be configured and/or set based on a number of options and/or attributes (e.g., “tree_model, “weightedsum”, true, [1.0, 1.0], {“indexMap”: “dynamicIndexMap”, “type”: “SPARSE” }”). Some or all of the options and/or attributes may also be included in a scoring function (e.g., “SCORING BY treeFeature”), a mapping of features (e.g., “[feature_1, feature_2]”) to parameters (e.g., “tree_model”) of the machine-learning model, and/or a training technique (e.g., “xgboost”) specified in the corresponding training configuration.

Next, the model definition and training configuration are used to load the machine-learning model and the set of required features into a training pipeline (operation 304). For example, a series of commands and/or calls may be used to load the model definition and training configuration from one or more configuration files, database records, and/or other formats. The commands and/or calls may also be used to specify hyperparameters and/or other options associated with executing the training pipeline.

The model definition and training configuration may be decoupled in a way that allows the model and required features to be loaded into the training pipeline without requiring a user to manually identify the required features. For example, the model definition may define the features by name, type, source, and/or formula (e.g., for calculating derived features), while the training configuration may identify the required features by name and/or association with the corresponding parameters in the model definition (e.g., a one-to-one mapping between features and parameters in a regression model).

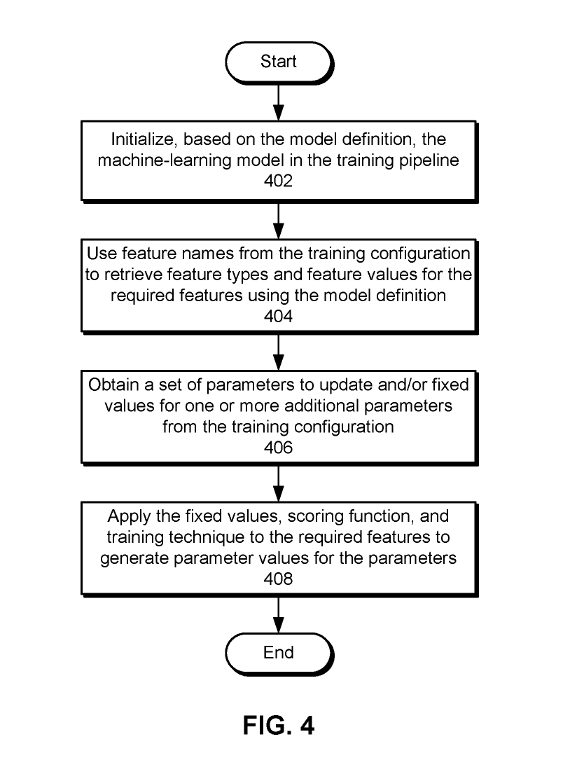

The training pipeline and training configuration are then used to update a set of parameters for the machine-learning model (operation 306), as described in further detail below with respect to FIG. 4. Finally, mappings containing the updated parameters and required features are stored in a representation of the machine-learning model (operation 308). For example, mappings of parameter values to features to which the corresponding parameters are applied may be stored in the model definition and/or another representation of the machine-learning model. The representation may then be used to generate scores, predictions, inferences, estimates, and/or other output from additional sets of features inputted into the machine-learning model, as discussed above.

FIG. 4 shows a flowchart illustrating a process of executing a training pipeline for a machine-learning model in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

First, the machine-learning model is initialized in the training pipeline based on the model definition (operation 402) for the machine-learning model. For example, the model definition and training configuration for the machine-learning model may be loaded from one or more configuration files into the training pipeline.

Next, feature names from the training configuration are used to retrieve feature types and feature values for the required features from the model definition (operation 404). For example, a feature name in the training configuration may be matched to a feature type and a feature source in the model definition, and one or more feature values for the feature name may be obtained from the feature source. In another example, a feature name in the training configuration may be matched to a feature type and a formula for calculating a derived feature from one or more other features in the model definition, and the formula and feature values of the other feature(s) are used to calculate a feature value for the derived feature.

A set of parameters to update and/or fixed values for one or more additional parameters are then obtained from the training configuration (operation 406). For example, the training configuration may include mappings of required features to parameters that will be trained using the required features. The training configuration may also identify one or more parameters that are omitted from training using the required features and/or other features. Instead, fixed and/or default values of the parameters may be obtained from the model definition and/or another source, along with a scoring function and/or training technique for the machine-learning model.

Finally, the fixed values, scoring function, and training technique are applied to the required features to generate parameter values for the parameters (operation 408). For example, the scoring function and training technique may be applied to the parameters, feature values of the required features, and/or fixed values of other parameters to generate parameter values that fit the machine-learning model to the feature values of the required features. The training of the machine-learning model may also be performed based on one or more hyperparameters provided to the training pipeline.

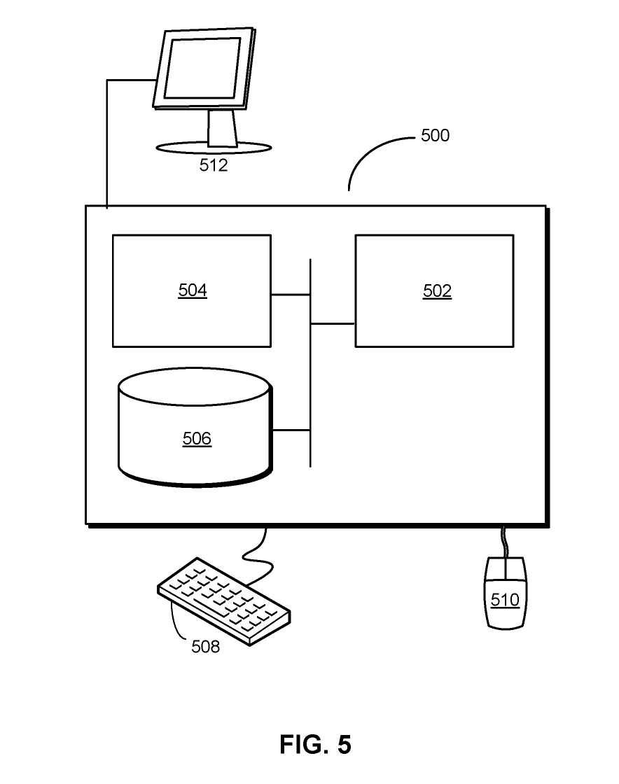

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include a model-creation apparatus and a training apparatus, one or more of which may alternatively be termed or implemented as a module, mechanism, or other type of system component. The model-creation apparatus obtains a model definition and a training configuration for a machine-learning model. Next, the model-creation apparatus uses the model definition and the training configuration to load the machine-learning model and the set of required features into a training pipeline without requiring a user to manually identify the set of required features. The training apparatus then uses the training pipeline and training configuration to update a set of parameters for the machine-learning model. Finally, the training apparatus stores mappings containing the updated set of parameters and the set of required features in a representation of the machine-learning model.

In addition, one or more components of computer system 500 may be remotely located and connected to the other components over a network. Portions of the present embodiments (e.g., model-creation apparatus, training apparatus, execution engine, feature repository, training pipeline, etc.) may also be located on different nodes of a distributed system that implements the embodiments. For example, the present embodiments may be implemented using a cloud computing system that configures and trains a set of remote statistical models.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a model definition and a training configuration for a machine-learning model, wherein the training configuration comprises a set of required features, a training technique, and a scoring function;
using the model definition and the training configuration to load, by one or more computer systems, the machine-learning model and the set of required features into a training pipeline without requiring a user to manually identify the set of required features;
using the training pipeline and the training configuration to update, by the one or more computer systems, a set of parameters for the machine-learning model; and
storing mappings comprising the updated set of parameters and the set of required features in a representation of the machine-learning model.

2. The method of claim 1, wherein using the model definition and the training configuration to load the machine-learning model and the set of required features into the training pipeline comprises:
initializing, based on the model definition, the machine-learning model in the training pipeline; and
using feature names from the training configuration to retrieve feature types and feature values for the set of required features from the model definition.

3. The method of claim 2, wherein using the feature names from the training configuration to retrieve the feature types and the feature values for the set of required features from the model definition further comprises:
matching a feature name in the training configuration to a feature type and a feature source in the model definition; and
obtaining a feature value for the feature name from the feature source.

4. The method of claim 2, wherein using the feature names from the training configuration to retrieve the feature types and the feature values for the set of required features from the model definition comprises:
matching a feature name in the training configuration to a feature type and a formula for calculating a derived feature from one or more other features in the model definition; and
using the formula and feature values of the one or more other features to calculate a feature value for the derived feature.

5. The method of claim 1, wherein the training configuration is obtained from the model definition.

6. The method of claim 1, wherein using the training pipeline and the training configuration to update the set of parameters for the machine-learning model comprises:
obtaining the set of parameters to update from the training configuration; and
applying the scoring function and the training technique to the set of required features to generate parameter values for the set of parameters.

7. The method of claim 6, wherein using the training pipeline and the training configuration to update the set of parameters for the machine-learning model further comprises:
obtaining fixed values for one or more additional parameters for the machine-learning model from the training configuration; and
using the fixed values with the scoring function and the training technique to generate the parameter values for the set of parameters.

8. The method of claim 1, wherein using the training pipeline and the training configuration to update the set of parameters for the machine-learning model comprises:
using one or more hyperparameters from the training pipeline to update the set of parameters for the machine-learning model.

9. The method of claim 1, wherein storing the mappings in the representation of the machine-learning model comprises:
storing the mappings in the model definition.

10. The method of claim 1, wherein the mappings comprise a mapping of parameter values for one or more parameters in the updated set of parameters to one or more features to which the one or more parameters are applied.

11. A system, comprising:
one or more processors; and
memory storing instructions that, when executed by the one or more processors, cause the system to:
obtain a model definition and a training configuration for a machine-learning model, wherein the training configuration comprises a set of required features, a training technique, and a scoring function;
use the model definition and the training configuration to load the machine-learning model and the set of required features into a training pipeline without requiring a user to manually identify the set of required features;
use the training pipeline and the training configuration to update a set of parameters for the machine-learning model; and
store mappings comprising the updated set of parameters and the set of required features in a representation of the machine-learning model.

12. The system of claim 11, wherein using the model definition and the training configuration to load the machine-learning model and the set of required features into the training pipeline comprises:
initializing, based on the model definition, the machine-learning model in the training pipeline; and
using feature names from the training configuration to retrieve feature types and feature values for the set of required features from the model definition.

13. The system of claim 12, wherein using the feature names from the training configuration to retrieve the feature types and the feature values for the set of required features from the model definition further comprises:
matching a feature name in the training configuration to a feature type and a feature source in the model definition; and
obtaining a feature value for the feature name from the feature source.

14. The system of claim 12, wherein using the feature names from the training configuration to retrieve the feature types and the feature values for the set of required features from the model definition comprises:
matching a feature name in the training configuration to a feature type and a formula for calculating a derived feature from one or more other features in the model definition; and
using the formula and feature values of the one or more other features to calculate a feature value for the derived feature.

15. The system of claim 11, wherein using the training pipeline and the training configuration to update the set of parameters for the machine-learning model comprises:
obtaining the set of parameters to update from the training configuration; and
applying the scoring function and the training technique to the set of required features to generate parameter values for the set of parameters.

16. The system of claim 15, wherein using the training pipeline and the training configuration to update the set of parameters for the machine-learning model further comprises:
obtaining fixed values for one or more additional parameters for the machine-learning model from the training configuration; and
using the fixed values with the scoring function and the training technique to generate the parameter values for the set of parameters.

17. The system of claim 11, wherein using the training pipeline and the training configuration to update the set of parameters for the machine-learning model comprises:
using one or more hyperparameters from the training pipeline to update the set of parameters for the machine-learning model.

18. The system of claim 11, wherein storing the mappings in the representation of the machine-learning model comprises:
storing the mappings in the model definition.

19. The system of claim 11, wherein the training configuration is obtained from the model definition.

20. A non-transitory computer-readable storage medium storing instructions that when executed by a computer cause the computer to perform a method, the method comprising:
obtaining a model definition and a training configuration for a machine-learning model, wherein the training configuration comprises a set of required features, a training technique, and a scoring function;
using the model definition and the training configuration to load the machine-learning model and the set of required features into a training pipeline without requiring a user to manually identify the set of required features;
using the training pipeline and the training configuration to update a set of parameters for the machine-learning model; and
storing mappings comprising the updated set of parameters and the set of required features in a representation of the machine-learning model.
